(19) United States
(12) Patent Application Publication
(10) Pub. No.: US 2006/0133673 A1
(43) Pub. Date: Jun. 22, 2006

(54) Apparatus and methods for hand coded image smoothing

(76) Inventors: Lionel Mougin, Le Chesnay (FR); Didier Le Maitre, Antony (FR); Philippe Gautier, Sceaux (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/013,824

(22) Filed: Dec. 16, 2004

(51) Int. Cl. G06K 9/00; G06K 9/68

(52) U.S. Cl. 382/218; 382/181

(57) ABSTRACT

Methods and apparatus for smoothing an image representation for printing and display purposes. The invention recognizes that for smoothing purposes, there are only a limited number of patterns that require such smoothing, normally not exceeding a few hundred. It is therefore practical to compare an input image to a plurality of pre-determined patterns. If a match is found, then the input image is replaced by a corresponding pattern that was empirically found to be more suitable for the purposes of printing or display. Alternate embodiments of both the methods and the apparatus are disclosed.

### BACKGROUND OF THE INVENTION

1. Field of the Invention

The present invention relates generally to a method for smoothing an input image for printing or display purposes.

2. Prior Art

It is a well known phenomenon that when printing or displaying an image, an artifact may occur which causes the displayed element to seem to have sharp, rather then smooth edges. This happens because the technology used for display or print requires breaking the image into a plurality of picture elements (pixels), each representing a single dot, or square, on a plane. In order to provide a more pleasing image to the eye, there is a need in the art to provide smoothing solutions that reduce the effects of such sharp edges.

There have been multiple attempts to resolve this issue as described in prior art. U.S. Pat. No. 6,501,565 proposes a method and apparatus whereby the smoothing is performed by grey scale reconstruction of the image. This process is performed by replacing a pixel with an average value in both horizontal and vertical directions. U.S. Pat. No. 6,181,437, suggests a different approach so as to produce images without jaggies at the edges. In this case the counting of pixels in both rows and columns is suggested and when a threshold is reached, replacing a pixel by a black pixel. U.S. Pat. No. 5,652,660 suggests the detection of an edge requiring smoothing by the use of a logic calculation circuit. Once this is determined, a selection is made from a plurality of pre-stored image options, generally by dividing one pixel into an optimal number of pixel sections on the basis of a designated resolution, and setting a logic circuit for performing an optimal smoothing processing. U.S. Pat. No. 5,611,023 suggests certain conversion mechanisms for a two-tone pixel where it is converted to a single multiple-tone pixel or a plurality of multiple-tone pixels. U.S. Pat. No. 5,537,515 suggests another method of smoothing an image, again based on the detection of the contour portion of the image. U.S. Pat. Nos. 5,450,208 and 5,351,315 further suggest circuits for smoothing images.

Notably, prior art solutions suggest circuits containing some processing means to handle the smoothing of an image. However, experience has shown that regardless of the sophistication of the algorithm used, there are always artifacts or imperfections that are either introduced or remain unresolved using such numerical techniques. In view of the limitations of the prior art, it would be advantageous to provide a solution that is easy to implement and upgrade as well as to provide empirical experiences as part of the smoothing process.

### BRIEF DESCRIPTION OF THE DRAWINGS

FIG. 1 is a schematic block diagram for an embodiment of the present invention for image smoothing.

FIGS. 2A and 2B are first exemplary patterns before and after smoothing operation, respectively.

FIGS. 3A and 3B are second exemplary patterns before and after smoothing operation, respectively.

FIG. 4 is an exemplary flowchart for image smoothing in accordance with the disclosed invention.

FIG. 5 is a schematic block diagram for an alternate embodiment of the present invention using a content addressable memory for image smoothing.

FIG. 6 is a schematic block diagram for a still further alternate embodiment of the present invention for image smoothing.

### DETAILED DESCRIPTION OF THE PREFERRED EMBODIMENTS

Smoothing of an image is necessary in order to create a printed or displayed image that is pleasing to the eye. When such smoothing is lacking or has shortfalls, the human eye is quick to detect the problem. The present inventors have noted that if an image is broken down to small segments of n-by-n pixels, where ‘n’ is an odd number, then it is possible to rectify these problems, also known as “jaggies”, by comparing the input pattern with a database of patterns known to displease the eye. The inventors have further found that the number of such patterns is fairly small, around two hundred or so, even when using a 9×9 pixel bi-level image pattern. This is a small fraction of the number of possible permutations that is a whooping two to the power of eighty-one (2⁸¹). In accordance with the disclosed invention, patterns found experimentally to be displeasing to the eye may be easily added to the database, thereby rectifying the situation with no need to develop new algorithms.

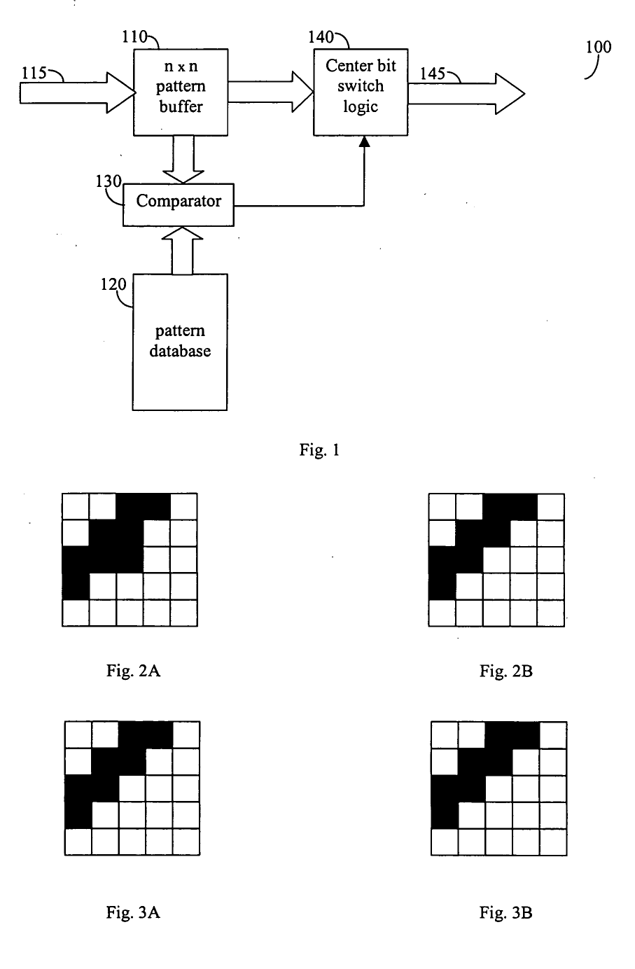

Reference is now made to FIG. 1 where an exemplary and non-limiting schematic block diagram 100 of an apparatus for the purpose of smoothing an input bi-level image pattern, is shown. An n-by-n bi-level pixel image pattern is provided over input means 115 to n-by-n pattern buffer 105. The pattern is compared to a plurality of patterns in database 120 by means of comparator 130. Pattern database 120 may be a semiconductor memory such as a read only memory (ROM), random access memory (RAM), non-volatile memory, for example Flash memory, content addressable memory (CAM) where database 120 and comparator 130 are in fact a single unit as explained in more detail below, cache, and the like. In another embodiment of the invention, pattern database 120 may be a storage media such as a compact disk (CD), digital videodisk (DVD), hard disk, and the like. When comparator 130 detects a match between a pattern in pattern database 120 and the pattern in n-by-n image buffer 110, then a switch signal is sent to center bit switch logic 140 which switches the bi-level value of the center bit of the input image to its other bi-level value, and outputs the image pattern on output means 145. A person skilled-in-the-art would easily note that this could be easily implemented using a XOR gate having as its two inputs the center bit and an active high match signal. In another embodiment of the invention, the system is implemented as a software only solution, and in yet another embodiment, it is implemented as a combination of hardware and software.

It should be noted that in any given point in time, the n-by-n bi-level pixel image pattern may be compared to one or more patterns contained in pattern database 120. By way of example, the database may have 20 memory locations, each storing 10 patterns. Thus there are 200 patterns, with 10 being simultaneously compared each time (on each database access). With such an implementation, it would take 20 clock cycles to complete the comparison. A hit in any one of the 10 comparator outputs would cause the center bit to be switched. Thus the memory requirements can be relatively small, though there is a performance penalty.

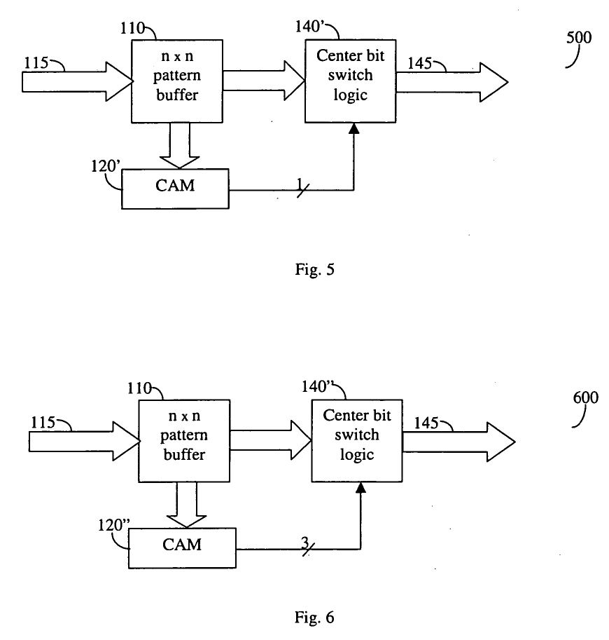

Another approach is to use a content addressable memory (CAM) having over 200 entries and loaded with the patterns. A CAM is a kind of storage device that includes comparison logic with each bit of storage. A data value, or in this case the n-by-n pattern segment, is broadcast to all stored pattern segments simultaneously and compared with the values therein. A pattern that matches causes a match signal to flag a hit. Thus the patterns are compared in parallel against an input pattern, and if a match is found in the CAM, a hit signal is generated. Such an embodiment is shown in FIG. 5. When a match is found in the CAM 120′, an output bit, for example the hit signal, is provided to center bit switch logic 140′, that is responsible to toggle the value of the center bit if a match was found. This implementation has a much higher performance (speed), but is more costly area and power wise.

Referring now to FIG. 2A, a 5-by-5 pixel pattern of an input pattern is shown. The input pattern is placed in the n-by-n pattern buffer 110 and compared against the database of image patterns therein. Assuming that a match is found, then the center bit is to be switched from its input bi-level value, in this case ‘black’, to the other bi-level value. This is shown in FIG. 2B where the result on output means 145 is shown for the input pattern with the switched center bit. Referring to FIG. 3A, a second input pattern is shown which also is to be processed as discussed above. However, in this case it is possible that there will not be a matching pattern in pattern database 120. In this case comparator 130 does not send a switching signal to center bit switch logic 140 and therefore the image pattern on output means 145, shown in FIG. 3B, is identical to the input pattern placed originally on input means 115. A person skilled in the art would clearly note that the implementation in accordance with the disclosed invention would essentially operate effectively on any n-by-n input pattern where ‘n’ is an odd number.

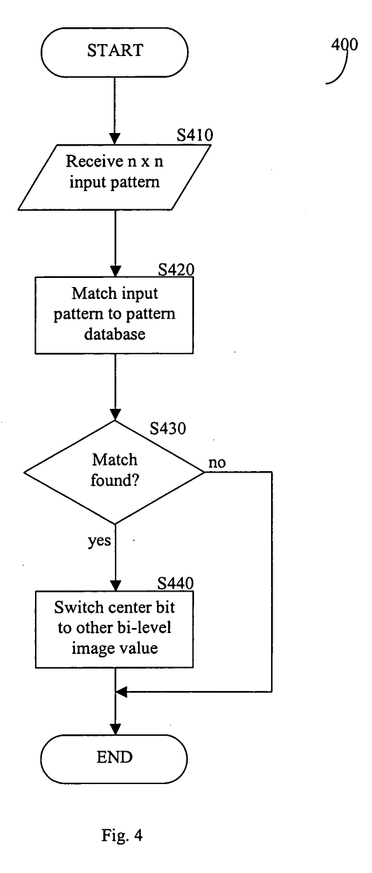

Reference is now made to FIG. 4 where an exemplary non-limiting flowchart 400 for image smoothing in accordance with the disclosed invention is shown. In block S410, an n-by-n input pattern is received. In block S420, the n-by-n input pattern is compared to a plurality of n-by-n image patterns stored in a pattern database. The pattern database may be a semiconductor memory such as a read only memory (ROM), random access memory (RAM), non-volatile memory, for example Flash memory, content addressable memory (CAM), cache, and the like. In another embodiment of the invention, the pattern database may be a storage media such as a compact disk (CD), digital videodisk (DVD), hard disk, or the like. In block S430, if a match is not found, execution is ceased; otherwise execution continues with block S440. In block S440, the center bit of the n-by-n input pattern is switched to the other bi-level value, for example, if the first bi-value was ‘0’, or ‘white’, it will be switched to ‘1’, or ‘black’.

In the preferred embodiment just described, a search of a database for an n-by-n pattern is made to find an exact match, and if found, the center bit is switched or toggled. However there are other ways to use a database of predetermined patterns in which a bit is or may be changed. By way of but one example, as shown in FIG. 6, a search of a database may be made based not on an exact match, but on a match of all but the center bit of the pattern. The reduced matching pattern is stored in one of a plurality of rows of a CAM 120″. As opposed to CAM 120′, CAM 120″ in response to finding a hit in the pattern matching provides to center bit switching logic 140″ not only the hit signal, but also two bits that have a value associated with the matched pattern. One of the bits provides switching indication for the case where the center bit is, for example, ‘black’, while the other bit provides switching indication for the case where the center bit has the opposite value, for example, ‘white’. In this case only n²−1 bits of the input n-by-n image pattern bits are compared against the data in CAM 120″. The use of a CAM would potentially significantly reduce the need for a large RAM addressable by, for example, 24 bits. Other variations will also become apparent.

While specific embodiments of the present invention and its various functional components have generally been described in particular hardware embodiments, it should be appreciated the present invention methods can be implemented in hardware, software, firmware, middleware or a combination thereof and utilized in systems, subsystems, components, or sub-components thereof. When implemented as a program, the elements of the present invention are the instructions or code segments to perform the necessary tasks. The instructions or code segments can be stored in a machine readable medium (e.g. a processor readable medium or a computer program product), or transmitted by a computer data signal embodied in a carrier wave, or a signal modulated by a carrier, over a transmission medium or communication link. The machine-readable medium may include any medium that can store or transfer information in a form readable and executable by a machine (e.g. a processor, a computer, etc.). Examples of the machine-readable medium include an electronic circuit, a semiconductor memory device, a ROM, a flash memory, an erasable programmable ROM (EPROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The instructions or code segments may be downloaded via networks such as the Internet, Intranet, etc.

Thus while certain preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. Apparatus for smoothing at least part of a bi-level image pattern, said apparatus comprising:
an n-by-n bit pattern buffer configured to store an n-by-n bit image segment wherein n is an odd number;
a storage device configured to store a plurality of pattern segments that may need smoothing;
at least one comparator configured to compare a plurality of pattern segments to be stored in the storage device with a corresponding part of an image segment to be stored in the pattern buffer; and,
center bit control circuitry responsive to a finding of comparison in a pattern segments to be stored in the storage device with a corresponding part of an image segment to be stored in the pattern buffer to set the center bit of the image segment to a predetermined state.

2. The apparatus of claim 1 wherein the storage device is configured to store a plurality of n-by-n pattern segments, and wherein the center bit control circuitry, when finding a comparison in a pattern segment stored in the storage device with an image segment stored in the pattern buffer, is configured to set the center bit of the image segment to a predetermined state by changing the state of the center bit.

3. The apparatus of claim 2 wherein the storage device comprises an addressable storage device configured to output a plurality of pattern segments for each address, and wherein the comparators comprise a number of comparators equal in number with the plurality of pattern segments that may be output from the storage device for each address.

4. The apparatus of claim 1 wherein:
the storage device is configured to store a plurality of 2ⁿ−1 bit pattern segments comprising all except the center bit of the n-by-n bit image segments that may be stored in the pattern buffer, and for each pattern segment that may be stored, to store control information respective of the desired state of the center bit;
the at least one comparator is configured to compare a plurality of 2ⁿ−1 bit pattern segments stored in the storage device with a corresponding part of an image segment stored in the pattern buffer; and,
the center bit control circuitry is responsive to a finding of comparison in a pattern segment stored in the storage device with a corresponding part of an image segment stored in the pattern buffer to set the center bit of the image segment to a state determined by control information respective of the desired state of the respective center bit to be stored in the storage device.

5. The apparatus of claim 1 wherein the n-by-n image segment is a 5 bit by 5 bit image segment.

6. Apparatus for smoothing a bi-level image input pattern, said apparatus comprising of:
input means for an n-by-n bit image input pattern, wherein said n is an odd value;
storage means for storing a plurality of n-by-n bit image patterns;
comparison means for comparing said n-by-n bit image input pattern to the plurality of n-by-n bit image patterns;
center bit switching means for switching the center bit of said n-by-n bit image input pattern from its original bi-level value to an opposite bi-level value upon indication of a match from said comparison means.

7. The apparatus of claim 6 wherein the comparison means is a means for simultaneously comparing said n-by-n bit image input pattern to a plurality of n-by-n bit image patterns.

8. Apparatus for smoothing a bi-level image input pattern, said apparatus comprising of:
input circuitry configured to receive n-by-n bit image input patterns;
a storage device configured to store a plurality of n-by-n bit image patterns;
at least one comparator configured to compare an n-by-n bit image input pattern in the storage device to a plurality of n-by-n bit image patterns in the storage device;
a center bit switch configured to switch the center bit of said n-by-n bit image input pattern from its original bi-level value to an opposite bi-level value upon indication of a match from said comparator.

9. The apparatus of claim 8 wherein the comparators are configured to simultaneously compare an n-by-n bit image input pattern to a plurality of n-by-n bit image patterns.

10. A method of smoothing a bi-level image input pattern comprising:
receiving an n-by-n bit image input pattern, wherein n is an odd value;
comparing the n-by-n bit image input pattern to a first plurality of n-by-n bit image patterns;
switching the value of the center bit of the n-by-n bit image input pattern to the other bi-level value upon detection of a match between the n-by-n bit image input pattern and at least a pattern of the first plurality of n-by-n bits image patterns.

11. The method of claim 10 wherein the comparing comprises comparing the n-by-n bit image input pattern to the first plurality of n-by-n bit image patterns simultaneously.

12. The method of claim 11 wherein at least the comparing is done in a content addressable memory.

13. The method of claim 10 wherein the comparing comprises simultaneously comparing the n-by-n bit image input pattern to second pluralities of n-by-n bit image patterns, where the second plurality is less than the first plurality.

14. A method of smoothing a bi-level image input pattern comprising:
receiving an n-by-n bit image input pattern, wherein n is an odd value;
comparing the n-by-n bit image input pattern, less its center bit, to a first plurality of n-by-n bit image patterns, each also less its center bit, whereby the image input pattern and the image patterns all have n²−1 bits;
upon detection of a match in the comparison, forcing the value of the center bit of the n-by-n bit image input pattern to a state associated with the matching pattern.

15. The method of claim 14 wherein the comparing comprises comparing the image input pattern, less its center bit, to second pluralities of image patterns, less their center bit, simultaneously, where the second plurality is less than the first plurality.

16. A machine readable medium that provides instructions which, when executed by a machine, causes the machine to perform operations smoothing a bi-level image input pattern comprising:
receiving an n-by-n bit image input pattern, wherein said n is an odd value;
comparing the n-by-n bit image input pattern to a plurality of n-by-n bit image patterns;
switching the value of the center bit of the n-by-n bit image input pattern to the other bi-level value upon detection of a match between the n-by-n bit image input pattern and one of said plurality of n-by-n bit image patterns.

17. A machine readable medium that provides instructions which, when executed by a machine, causes the machine to perform operations smoothing a bi-level image input pattern comprising:
receiving an n-by-n bit image input pattern, wherein said n is an odd value;
comparing the n-by-n bits image input pattern, less its center bit, to a plurality of n-by-n bit image patterns, each also less it center bit, whereby the image input pattern and the image patterns each have n²−1 bits;
upon detection of a match during the comparison, forcing the value of the center bit of the n-by-n bit image input pattern to a state associated with the matching pattern.
